(19) United States
(12) Patent Application Publication
(10) Pub. No.: US 2026/0299888 A1
(43) Pub. Date: Oct. 1, 2026

(54) PROGRAM GENERATION DEVICE, METHOD, AND STORAGE MEDIUM

(71) Applicant: FANUC CORPORATION, Minamitsuru-gun, Yamanashi (JP)

(72) Inventor: Yuusuke KURIHARA, Yamanashi (JP)

(73) Assignee: FANUC CORPORATION, Minamitsuru-gun, Yamanashi (JP)

(21) Appl. No.: 18/992,774

(22) PCT Filed: Nov. 29, 2022
(86) PCT No.: PCT/JP2022/043895

§ 371 Date: Jan. 9, 2025

(51) Int. Cl. G06F 8/30

(52) U.S. Cl. CPC G06F 8/30

(57) ABSTRACT

This program generation device includes a processor, a storage device, a display, and an input device. The processor: reads at least one operation symbol, which includes information that relates to an operation command for a robot and is registered in advance within the storage device, displays the at least one operation symbol in a first region of the display; reproduces one or more operation symbols, which are selected from the at least one operation symbol displayed in the first region, and arranges the resultant symbol in a second region of the display, thereby generating an operation program; causes the input device to input a parameter pertaining to a function represented by any of the operation symbols selected from the operation symbols displayed in the first and second regions, thereby generating a parameter-including operation symbol; and registers the generated parameter-including operation symbol in the storage unit as one operation symbol.

This application is a national phase of International Application No. PCT/JP2022/043895 filed Nov. 29, 2022, which is hereby incorporated by reference in its entirety.

### TECHNICAL FIELD

The present disclosure relates to program generation devices, methods, and programs.

### BACKGROUND ART

There has hitherto been a known type of teaching device in which, in response to dragging of an icon displayed in a selection region of a teaching screen, an icon that is the same as the dragged icon is reproduced, and the reproduced icon is moved to a creation region (e.g., Patent Literature 1).

It is possible to generate an operation program for a robot by arranging a plurality of icons in the creation region. In relation to each of the icons reproduced in the creation region, a user can set parameters for a function represented by the icon via a status window provided for that

### CITATION LIST

### Patent Literature

### {PTL 1}

PCT International Publication No. WO 2020/012558

### SUMMARY OF INVENTION

An aspect of the present disclosure is a program generation device comprising at least one processor, at least one storage device, a display, and an input device, wherein the processor: reads at least one operation symbol, which includes information that relates to an operation command for a robot and is registered in advance within the storage device, from the storage device and displays the at least one operation symbol in a first region of the display; reproduces one or more operation symbols, which are selected from the at least one operation symbol displayed in the first region, and arranges the one or more operation symbols in time series in a second region of the display, thereby generating an operation program; accepts input, via the input device, of a parameter for a function represented by an operation symbol selected from the operation symbols displayed in the first region or the second region, thereby generating a parameter-including operation symbol; and registers the generated parameter-including operation symbol in the storage device as one of the operation symbols.

### BRIEF DESCRIPTION OF DRAWINGS

FIG. 1 is an illustration showing an example robot system to which a program generation device according to a first embodiment of the present disclosure is applied.

FIG. 2 is a block diagram showing the program generation device in FIG. 1.

FIG. 3 is an illustration showing an example of what is displayed on a display in the program generation device in FIG. 2.

FIG. 4 is an illustration showing an example parameter setting region and name setting region displayed on the display in the program generation device in FIG. 2.

FIG. 5 is an illustration showing an example of parameter-including icons reproduced in a selection region at the program generation device in FIG. 2.

FIG. 6 is an illustration showing a state in which a parameter-including icon has been reproduced in favorites at the program generation device in FIG. 2.

FIG. 7 is a flowchart for explaining a program generation method according to the first embodiment of the present disclosure.

FIG. 8 is an illustration showing a modification of the display in the program generation device in FIG. 2.

FIG. 9 is an illustration in which checkboxes for selecting parameters to be registered have been added in the parameter setting region in FIG. 4.

FIG. 10 is an illustration for explaining a program generation device according to a second embodiment of the present disclosure, showing an example of what is displayed on a display.

FIG. 11 is an illustration showing a state in which a reproduction icon has been generated in a selection region as a result of reproducing a plurality of icons in a creation region.

FIG. 12 is an illustration showing an example name input region via which a name is input for the reproduction icon in FIG. 10.

FIG. 13 is an illustration showing an example of what is displayed for checking the content of the reproduction icon in FIG. 10.

FIG. 14 is an illustration showing an example of what is displayed for checking whether or not to maintain parameters when the reproduction icon in FIG. 10 is reproduced in the creation region.

### DESCRIPTION OF EMBODIMENTS

A program generation device 1, a method, and a program according to a first embodiment of the present disclosure will be described below with reference to the drawings.

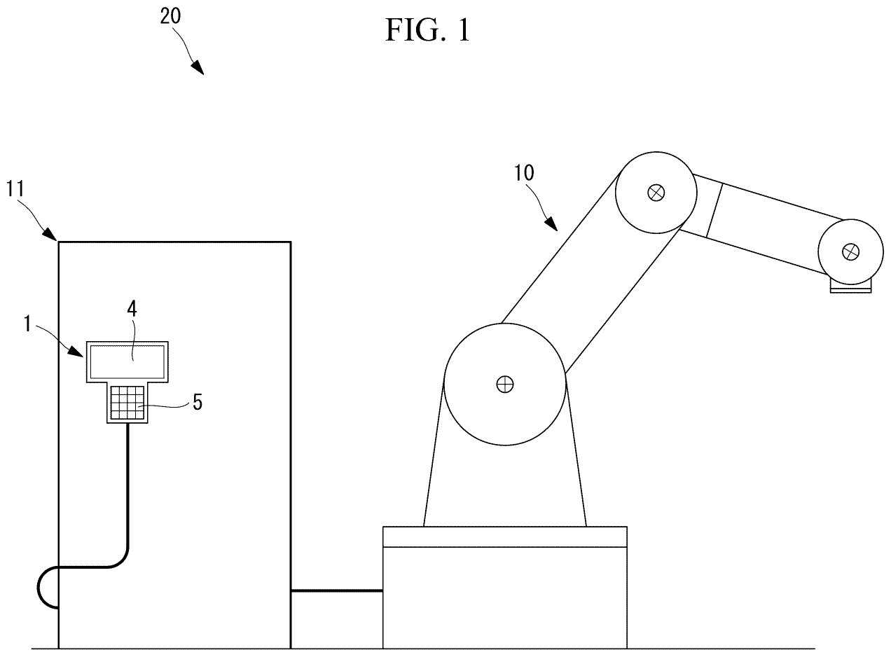

As shown in FIG. 1, the program generation device 1 according to this embodiment is applied to a robot system 20 including a robot 10 and a control device 11 that controls the robot 10.

The robot 10 is, for example, a six-axis vertically articulated robot and is driven according to a control signal output from the control device 11. The robot 10 is not limited to a six-axis vertically articulated robot and may be any type of robot, such as a horizontally articulated robot or a linear robot.

The control device 11 reads out an operation program stored in a storage device 3, which will be described later, generates a control signal on the basis of the operation program read out, and outputs the control signal to the robot 10. The operation program is a program for causing the robot 10 to operate and is command data including one or more operation commands.

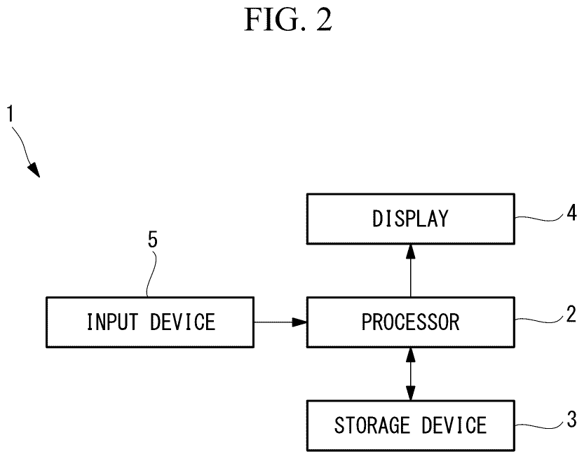

The program generation device 1 according to this embodiment is a device that creates an operation program according to operations performed by a user. Here, creating an operation program includes editing of an existing operation program as well as newly creating an operation program. As shown in FIG. 2, the program generation device 1 includes at least one processor 2, at least one storage device 3, a display 4, and an input interface (input device) 5.

The processor 2 may be any processing device, such as a CPU or an MPU. Furthermore, processing to be executed by the processor 2 may be partially realized by means of a dedicated logic circuit or hardware.

The storage device 3 includes at least one of a semiconductor memory such as a random access memory (RAM) or a read-only memory (ROM) and a storage device such as a hard disc drive (HDD), an optical disk, or the like.

The display 4 is implemented by a liquid crystal display, an organic EL display, or the like. The input interface 5 is implemented by a touch panel device, a keyboard and a mouse, or the like.

The program generation device 1 may be a dedicated teaching device such as a teaching console panel provided in the control device 11 or may be a general-purpose computer, a tablet, or the like having a program generation program installed therein.

The program generation device 1 according to this embodiment stores at least one operation symbol including information concerning an operation command for the robot 10, registered in advance in the storage device 3. Operation symbols are, for example, various icons I representing various operation commands for the robot 10 (hereinafter referred to as icons). The operation commands include a linear movement instructions, an arc movement instruction, an instruction for driving a tool attached to the distal end of the robot 10, etc.

The icons I include icons with which it is possible to set parameters for the functions represented by the icons I, as well as icons with which it is not necessary to set parameters. For example, for a movement instruction, the parameters include a target position, a midway position, a movement speed, or the like.

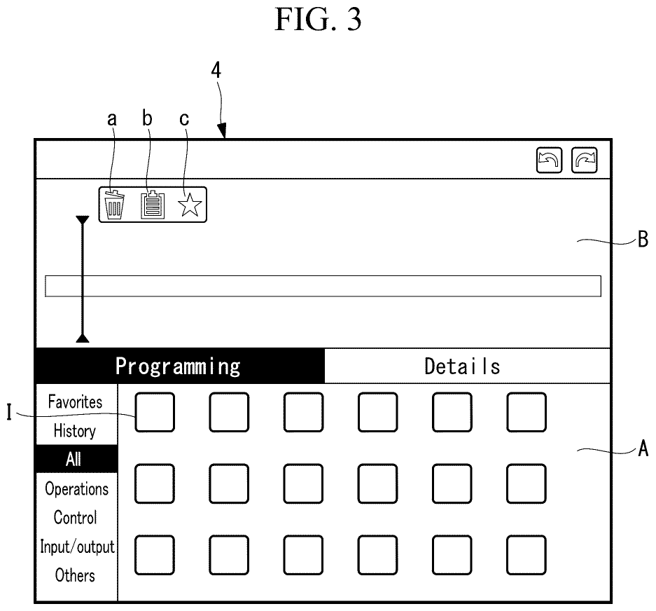

As shown in FIG. 3, the processor 2 reads out the icons I stored in the storage device 3 from the storage device 3 and displays the icons I in a selection region (first region) A of the display 4 in such a manner that the user can select the icons I. The user can select one of the icons I displayed in the selection region A by using the input interface 5. The user can select an icon I via a touch panel or by moving a cursor displayed on the display 4 by using a mouse or the like.

When the user selects the icon I displayed in the selection region A by using the input interface 5 and drags (reproduction operation) the icon I into a creation region (second region) B, the processor 2 reproduces the dragged icon I. Then, when the user moves the dragged icon I into the creation region B of the display 4 and drops the dragged icon I, the processor 2 disposes the icon I in the vicinity of the position where the icon I has been dropped in the creation region B.

The position where the icon I is dropped in the creation region B need not be strict, and in the case where the icon I is dropped in an arbitrary empty space in the creation region B, for example, the icon I is arranged in a left-justified manner. Furthermore, in the case where other icons I have already been disposed in the creation region B, the position where the new icon I is to be disposed is determined depending on the relative positional relationships thereof with those icons I. For example, in the case where two icons I are arranged in the creation region B, when the new icon I is dropped in the creation region B in the vicinity of the midpoint between the existing icons I, the new icon I is disposed between the two existing icons I.

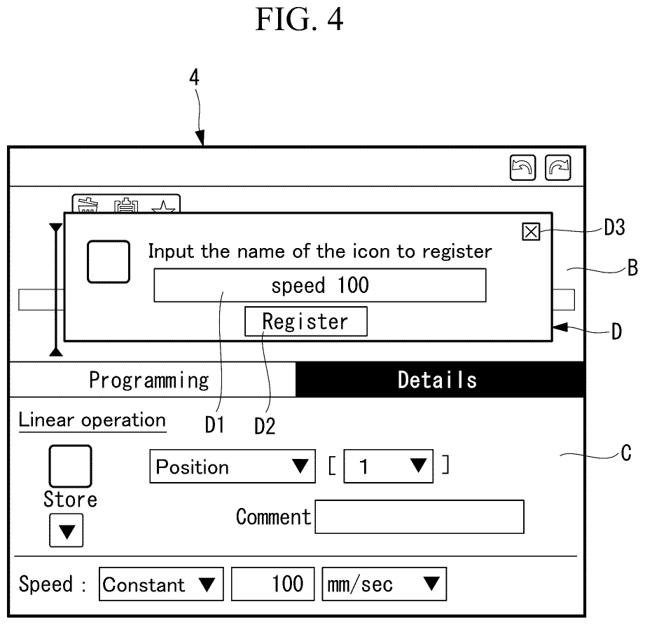

The user can select any of the icons displayed in the creation region B by using the input interface 5. When the user selects an icon I to which parameters can be set, displayed in the creation region B, the processor 2 displays a parameter setting region C on the display 4. For example, the parameter setting region C may be displayed in the form of a popup at an arbitrary position on the display 4, or may be displayed instead of the selection region A, as shown in FIG. 4. When the user has input parameters in the parameter setting region C via the input interface 5, the processor 2 stores the input parameters in the storage device 3, in association with the selected icon I on the creation region B.

As the user repeats these operations, the processor 2 can arrange a plurality of icons I in the creation region B, for example, horizontally along a timeline set from left to right in the creation region B. Accordingly, by horizontally arranging icons I, the processor 2 generates an operation program in which the icons I are arranged in time series along the timeline.

Furthermore, as shown in FIG. 3, the processor 2 displays an icon deletion mark a, a reproduction mark b, and an icon registration mark c on the display 4 in such a manner that these marks can be selected.

When the user selects one of the icons I displayed in the selection region A or the creation region B of the display 4 and then presses the icon registration mark c, the processor 2 displays a name setting region D for setting a name for the icon I. For example, the name setting region D is displayed in the form of a popup on the creation region B of the display 4 in the example shown in FIG. 4.

The name setting region D includes: an input region D1 for allowing the user to input arbitrary text representing the name of the icon I; a registration button D2 for fixing and registering the input name; and a cancel button D3 for quitting processing. When the user has input arbitrary text representing a name in the input region D1 and has pressed the registration button D2, the processor 2 generates a new icon I including the input name in the selection region A.

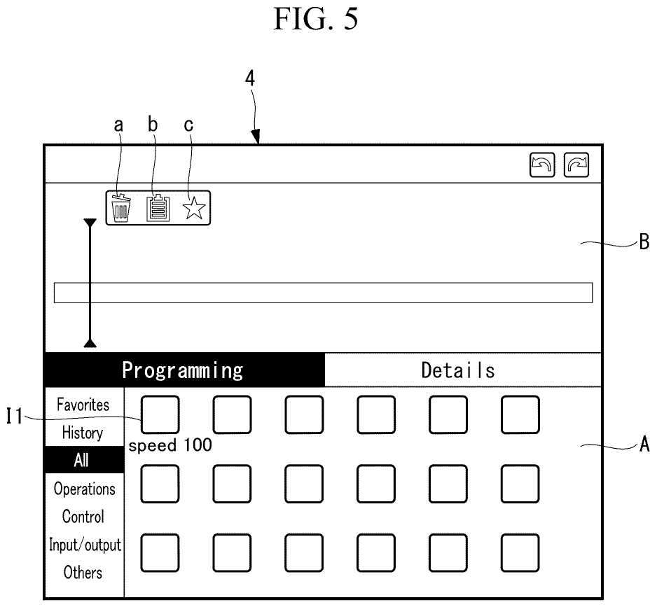

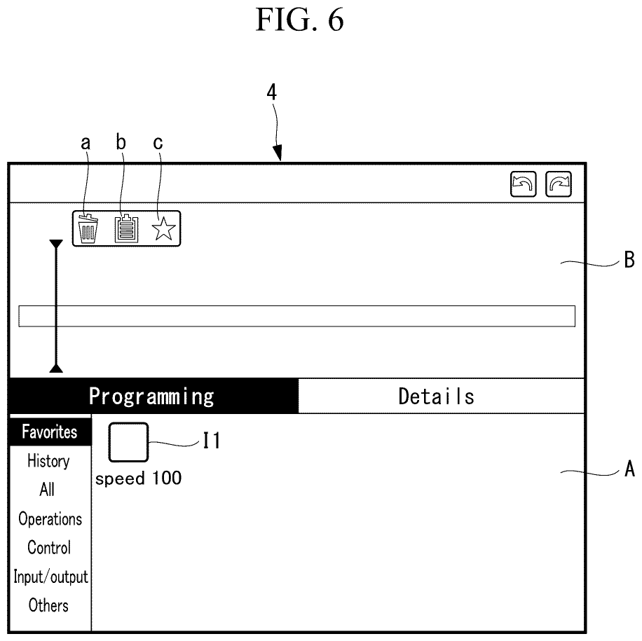

That is, as shown in FIG. 5, the processor 2 stores (registers) a new icon I1 having the input name (e.g., speed 100) in the storage device 3 as one of the icons I to be displayed in the selection region A. As shown in FIG. 6, the newly registered icon I1 may be registered in favorites.

In this case, in the case where an icon I has set thereto parameters representing the functions of that icon I, the processor 2 reproduces a parameter-including icon parameter-including operation symbol having the parameters set thereto. In the case where an icon I to which parameters can be set but have not been set is selected, as shown in FIG. 4, the processor 2 displays the parameter setting region C on the display 4, prompting the user to input parameters.

When a parameter-including icon has been registered, similarly to the other icons I, the user can select the parameter-including icon displayed in the selection region A and can reproduce the parameter-including icon in the creation region B by dragging and dropping. When the parameter-including icon has been reproduced in the creation region B, the parameters set to the icon I are maintained without being changed.

When the user has selected an icon group including a plurality of icons I arranged in the creation region B of the display 4 and has pressed the reproduction mark b, the processor 2 generates an arbitrary reproduction icon I2.

Meanwhile, when the user has selected an unnecessary icon I displayed in the selection region A and has pressed the icon deletion mark a, the processor 2 deletes an arbitrary icon I registered in the storage device 3.

Next, a program generation method according to this embodiment will be described below with reference to the drawings.

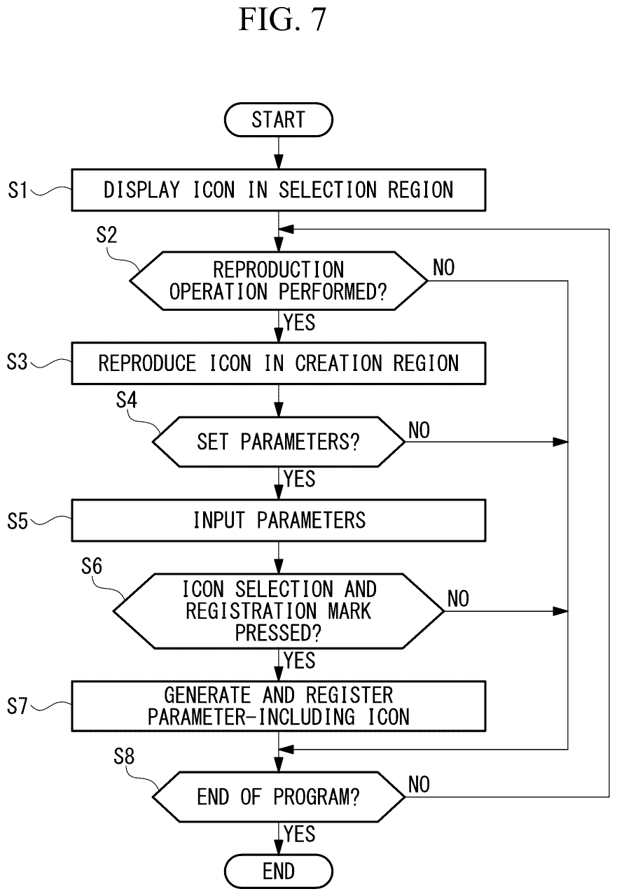

As shown in FIG. 7, the program generation method according to this embodiment includes step SI for reading out at least one icon I registered in advance in the storage device 3 from the storage device 3 and displaying the icon I in the selection region A of the display 4. Furthermore, the program generation method includes step S3 for generating an operation program by reproducing one or more icons I selected from the icons I displayed in the selection region A and arranging the icons I in time series in the creation region B. Furthermore, the program generation method includes step S5 for generating a parameter-including icon by accepting input of parameters for an icon I selected from the icons I displayed in the selection region A or the creation region B. Furthermore, the program generation method includes step S7 for registering the generated parameter-including icon in the storage device 3 as one of the icons I.

In the example shown in FIG. 7, icons I are displayed in the selection region A (step S1), and in the case where the user has dragged one of the icons I (step S2), the dragged icon I is reproduced (step S3). Then, the reproduced icon I is dropped in the creation region B, whereby an operation program is generated progressively.

It is determined whether or not the icon I dropped in the creation region B is an icon to which parameters can be set, and the parameter setting region C is displayed in the case where the icon I is an icon to which parameters can be set.

When the user has input parameters (step S5) and has pressed the icon registration mark c (step S6), the name setting region D is displayed.

When the user has input a name in the input region D1 and has pressed the registration button D2, a parameter-including icon is generated and is registered in the storage device 3 as one of the icons I (step S7). It is determined whether or not to finish program generation (step S8), and the steps from step S2 are repeated in the case where program generation is not to be finished.

Meanwhile, in the case where the user has dragged none of the icons I in step S2 among the icons I displayed in the selection region A in which the icons I are displayed in step S1, the process proceeds to step S8.

Meanwhile, also in the case where it is determined that the icon registration mark c has not been pressed in step S6 for the icon I for which parameters have been input in step S5, the process proceeds to step S8.

Furthermore, in the case where it is determined in step S4 that the icon I reproduced in step S3 is an icon I that does not require parameter setting, the process proceeds to step S8. When the parameter-including icon has been registered in the storage device 3, the newly registered parameter-including icon is included in the icons I displayed in the selection region A in step S1.

As described above, according to this embodiment, with a device that generates an operation program by arranging one or more icons I in the creation region B of the display 4, it is possible to register a parameter-including icon as a selectable icon I. Thus, even in the case where the same parameter-including icon is used a plurality of times in an operation program, there is no need to reset parameters for each icon I from scratch. Therefore, an advantage is afforded in that, even in such cases, the user can readily reuse icons I without performing the laborious work of resetting parameters.

Furthermore, also in the case where a parameter-including icon displayed in the creation region B is reproduced, it is possible to reproduce the parameter-including icon together with the parameters in the selection region A.

The program generation device 1 and program generation method according to this embodiment have been described in the context of an example where a single parameter-including icon is reproduced in the selection region A from a single parameter-including icon. Alternatively, a plurality of parameter-including icons may be reproduced in the selection region A from a single parameter-including icon.

In this case, different names should be input in the name setting region D displayed as a result of selecting one of the icons displayed in the selection region A and pressing the icon registration mark c. It is possible to reproduce a plurality of parameter-including icons made from the same kind of icon I by selecting a parameter-including icon displayed in the selection region A, pressing the icon registration mark c, and inputting names.

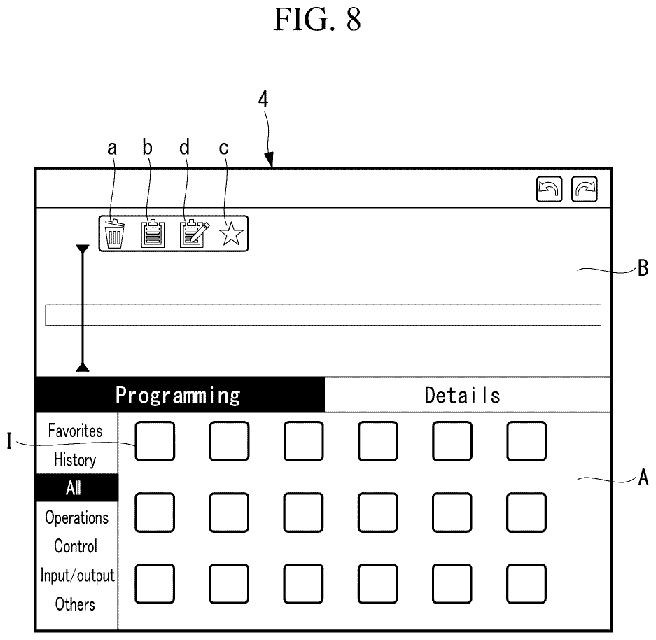

Furthermore, as shown in FIG. 8, an edit mark d may be displayed on the display 4 such that the processor 2 displays the name setting region D and the parameter setting region C also when the user has pressed the edit mark d, which makes it possible to edit names and parameters.

Furthermore, a parameter-including icon may be created by selecting an icon I displayed in the selection region A and not having parameters registered therefor and newly registering parameters.

Furthermore, the arrangement may be such that when registering and reproducing a parameter-including icon, the processor 2 may display parameters stored in association with the icon I, allowing the user to edit the parameters. By letting the user edit parameters at the time of registration, it is possible to save the labor of registering the same kind of parameter-including icon having different parameters.

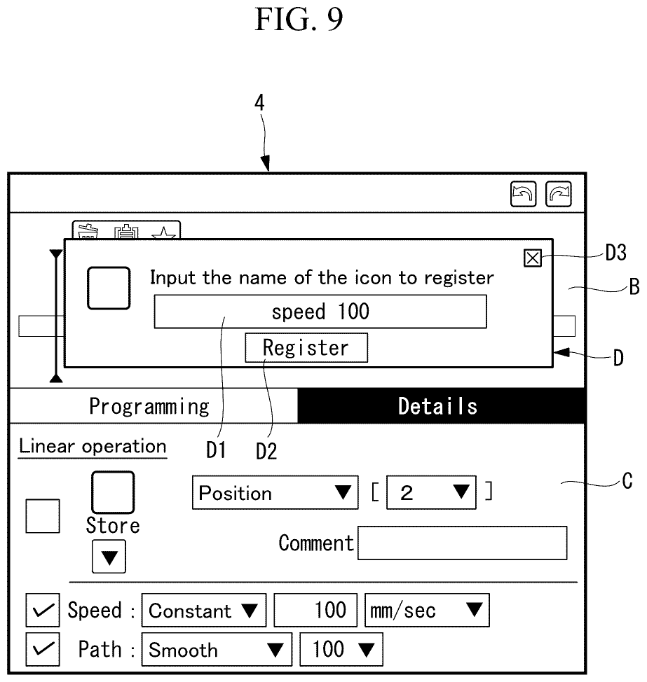

Furthermore, in the case of reproducing a parameter-including icon having a plurality of parameters, the processor 2 may display the parameter setting region C together with the name setting region D, letting the user select a parameter to be reproduced. For example, as shown in FIG. 9, parameter selection may be performed by the user checking a checkbox for the parameter to be reproduced.

For example, in the case where position information, speed information, and path information have been registered as parameters, for example, the user may check only the speed information and the path information and may then press the registration button D2.

In this case, the processor 2 registers a parameter-including icon in which only the speed information and the path information have been inherited, while not inheriting the position information set to the parameter-including icon serving as the original for reproduction, in the storage device 3. The position information for the reproduced parameter-including icon need not be set, or default position information may be set.

Furthermore, instead of allowing the user select a parameter to be reproduced when registering a parameter-including icon, the user may be allowed to select a parameter to be reproduced when reproducing a parameter-including icon displayed in the selection region A into the creation region B. In this case, the user should check the checkbox for the parameter to be reproduced when the user drags a parameter-including icon displayed in the selection region A into the creation region B to reproduce the parameter-including icon. Furthermore, the arrangement may be such that it is possible to select a parameter not to be inherited by unchecking the checkbox for that parameter.

Although the program generation device 1 and the program generation method have been described in the context of this embodiment, there is no limitation thereto. As described earlier, the present invention may be embodied in the form of a dedicated teaching device having the configuration described above, or a general-purpose computer, a tablet, or the like having a program generation program installed therein.

In this case, it suffices for the program generation program to cause a general-purpose computer, a tablet, or the like to execute the individual steps of the program generation method described above. Furthermore, although icons have been given as an example of operation symbols, operation symbols of any other kind may be adopted instead.

Next, a program generation device 1, a method, and a program according to a second embodiment of the present disclosure will be described below with reference to the drawings.

The first embodiment has been described in the context of the case where a single parameter-including icon is reproduced and is used. This embodiment differs from the first embodiment in that a plurality of icons I are reproduced and are used.

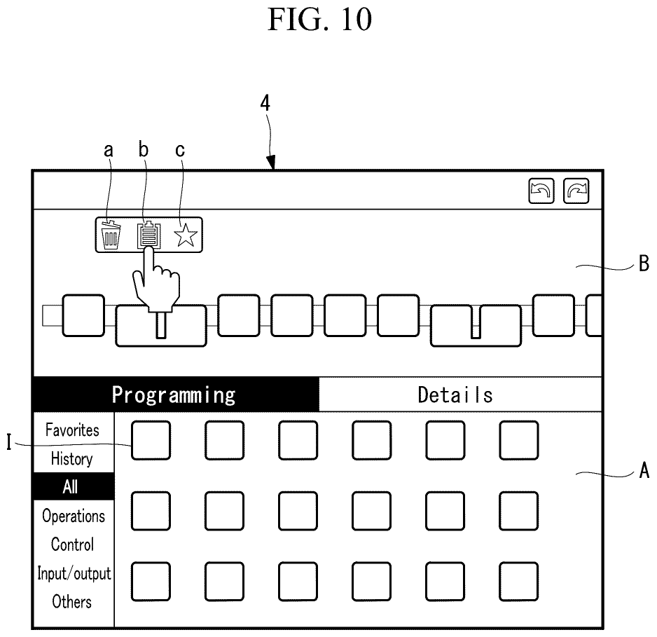

This embodiment is processing in a state where at least a portion of an operation program has been generated by reproducing icons I displayed in the selection region A and arranging the icons I in the creation region B and then setting parameters for some of the icons I. As shown in FIG. 10, in the creation region B, an operation program in which a plurality of icons I are arranged, or a portion thereof, is displayed.

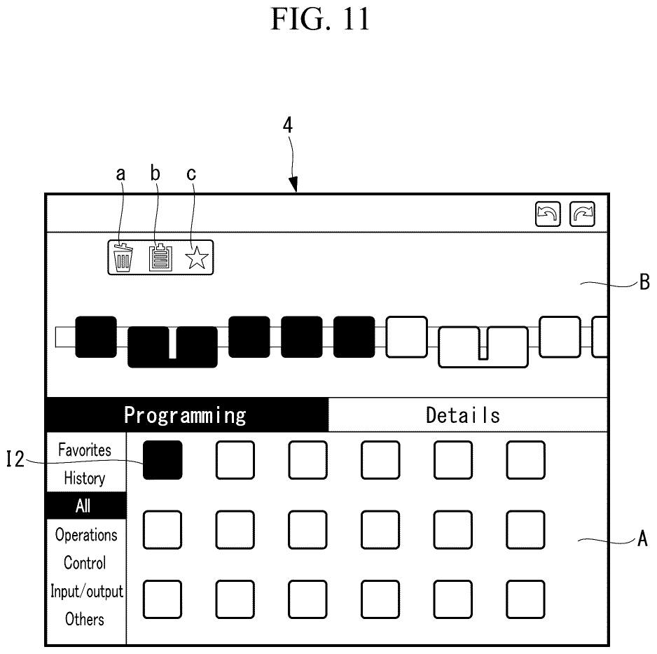

When the user has selected an icon group including a plurality of icons I arranged in the creation region B and has dragged the icon group into the selection region A, as shown in FIG. 11, the processor 2 generates a reproduction icon (reproduction symbol) representing the icon group. Alternatively, when the user has selected an icon group and then presses the icon registration mark c displayed on the display 4, the processor 2 generates a reproduction icon I2.

The reproduction icon 12 is a single icon I representing the selected icon group. Then, the processor 2 registers the generated reproduction icon 12 in the storage device 3 as one of the icons I.

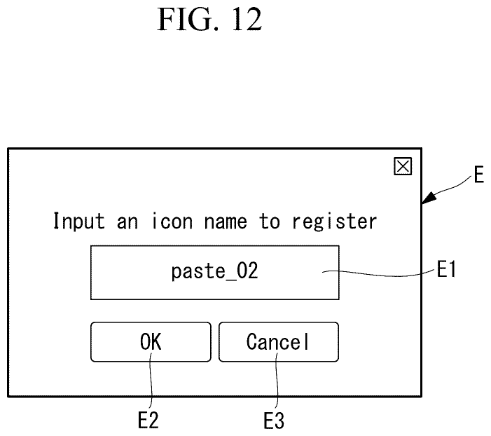

When the reproduction icon 12 has been generated, the processor 2 displays a name setting region E for setting a name for the reproduction icon 12. For example, as shown in FIG. 12, the name setting region E is displayed in the form of a popup at an arbitrary position on the display 4.

The name setting region E includes: an input region E1 for allowing the user to input arbitrary text representing a name for the reproduction icon 12; a registration button E2 for fixing and registering the input name; and a cancel button E3. When the user has entered arbitrary text representing a name and has pressed the registration button E2, the processor 2 generates a reproduction icon 12 having the input name attached thereto in the selection region A. That is, the processor 2 stores (registers) a reproduction icon 12 having the input name in the storage device 3 as one of the icons I to be displayed in the selection region A.

In this case, in the case where at least one icon I constituting the icon group has parameters set thereto, the processor 2 generates a reproduction icon 12 while maintaining the parameters. When the reproduction icon 12 has been registered, the user can select the reproduction icon I2 displayed in the selection region A and can reproduce the reproduction icon 12 in the creation region B by dragging and dropping, similarly to the other icons I.

Furthermore, when the reproduction icon 12 is reproduced into the creation region B, the reproduction icon 12 is reproduced in the form expanded into the icon group constituting the reproduction icon 12. The parameters set to at least one icon I constituting the icon group are maintained as they are.

The program generation method according to this embodiment includes the following steps in addition to the program generation method according to the first embodiment.

That is, in the case, a reproduction icon 12 is generated in the case where an icon group displayed in the creation region B has been selected and the reproduction mark b has been pressed or the icon group has been dragged into the selection region A. Then, the generated reproduction icon I2 is registered in the storage device 3 as one of the icons I.

As described above, according to this embodiment, it is possible to register an icon group including a plurality of icons I arranged in the creation region B as a selectable reproduction icon 12. Accordingly, in the case where the same icon group is used a plurality of times in an operation program, it is possible to copy and paste the icon at once.

In particular, in the case where at least one icon I constituting the icon group has parameters set thereto, there is no need to reset parameters from scratch for each of the icons I in the reproduced icon group. Therefore, an advantage is afforded in that, even in such cases, the user can readily reuse the icons I without the laborious work of resetting parameters.

Note that in this embodiment, when reproducing an icon group including a plurality of icons I in the selection region A, a single reproduction icon 12 into which the icon group is gathered is generated. It is not possible to check the icon group, which is the content of the reproduction icon I2 displayed in the selection region A, only from the appearance and name thereof.

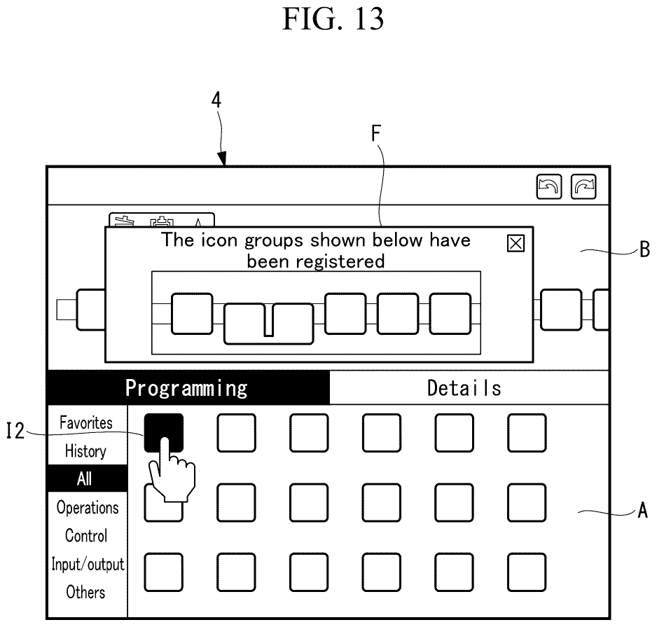

Thus, as shown in FIG. 13, the arrangement may be such that when the reproduction icon 12 displayed in the selection region A has been selected, the icon group indicating the content of the reproduction icon 12 is displayed on the display 4. For example, when the reproduction icon 12 has been selected, the icon group indicating the content of the reproduction icon 12 should be displayed in a content display region F displayed in the form of a popup.

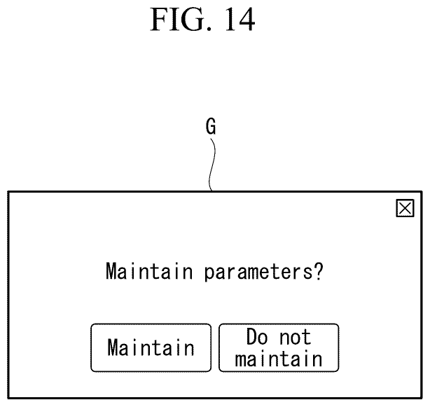

Furthermore, as shown in FIG. 14, the arrangement may be such that in the case where a reproduction icon 12 including an icon I having parameters set thereto is reproduced in the creation region B, a confirmation region G for confirming whether or not to maintain the set parameters in performing reproduction is displayed. In the case where it is determined to maintain the parameters, the icon I is reproduced while maintaining the parameters. In the case where it is determined not to maintain the parameters, the parameter setting may be cancelled, or default parameters may be set.

Furthermore, each of the above embodiments has been described in the context of an example where an icon I or icon group having parameters set thereto is used a plurality of times when generating the same operation program.

Alternatively, a parameter-including icon or reproduction icon 12 stored in the storage device 3 may be used when generating a different operation program.

Furthermore, each of the above embodiments has been described in the context of an example where an icon I or icon group having parameters set thereto is used a plurality of times when generating an operation program. Alternatively, as a reference example, the present invention may be applied to the case where an operation program is generated by using, a plurality of times, an icon group constituted of a plurality of icons I not having parameters set thereto.

That is, the arrangement may be such that a plurality of icons I not having parameters set thereto are selected in the creation region B, a reproduction icon 12 is generated by dragging or by pressing the icon registration mark c, and the reproduction icon 12 is registered in the storage device 3.

By registering the reproduction icon 12 as one of the icons I even in the case where parameters are not set, it is possible to considerably improve the ease of operation, similarly to the above.

Furthermore, although an example in which a reproduction icon 12 is generated by way of a reproduction operation has been given as an example, alternatively, a reproduction icon 12 may be generated by way of a cut operation. For example, a reproduction icon 12 may be generated when an operation for cutting an icon group in the creation region B has been performed and then an operation for pasting the icon group in the selection region A has been performed.

Thus, in the case where the positions of a plurality of selected icons I in an operation program are to be changed, it is possible to readily execute the insertion of the icons I at arbitrary positions in the operation program from the selection region A.

Furthermore, in the embodiments described above, linear movement instructions, arc movement instructions, instructions for driving a tool attached to the distal end of the robot 10, etc. have been given as example operation commands; however, operation commands are not limited thereto. Operation instructions may include arbitrary operation instructions necessary in an operation program, such as conditional branch instructions, register values, and I/O operation instructions.

Although the embodiments of the present disclosure have been described above in detail, the present disclosure is not limited to the individual embodiments described above. With these embodiments, various additions, substitutions, modifications, partial deletions, etc. are possible within the range not departing from the scope of the invention or within the range not departing from the idea and gist of the present invention as derived from the content specified in claims as well as equivalents thereof. For example, the order of the individual operations and the order of the individual processing steps in the embodiments described above are given as an example, and there is no limitation to these orders.

The following appendices are further disclosed in relation to the above embodiments and modifications.

### (Appendix 1)

A program generation device comprising at least one processor, at least one storage device, a display, and an input device, wherein the processor: reads at least one operation symbol, which includes information that relates to an operation command for a robot and is registered in advance within the storage device, from the storage device and displays the at least one operation symbol in a first region of the display; reproduces one or more operation symbols, which are selected from the at least one operation symbol displayed in the first region, and arranges the one or more operation symbols in a second region of the display, thereby generating an operation program; accepts input, via the input device, of a parameter for a function represented by an operation symbol selected from the operation symbols displayed in the first region or the second region, thereby generating a parameter-including operation symbol; and registers the generated parameter-including operation symbol in the storage device as one of the operation symbols.

### (Appendix 2)

The program generation device according to Appendix 1, wherein the processor accepts input, via the input device, of a name to be associated with the parameter-including operation symbol in response to registration of the parameter-including operation symbol in the storage device.

### (Appendix 3)

The program generation device according to Appendix 1 or 2, wherein the processor accepts, via the input device, editing of a parameter input to the parameter-including operation symbol in response to selection of the parameter-including operation symbol.

### (Appendix 4)

The program generation device according to any one of Appendices 1 to 3, wherein the processor: in response to selection of an operation symbol group including a plurality of the operation symbols arranged in the second region, generates a single reproduction symbol representing the operation symbol group; and registers the generated reproduction symbol in the storage device as one of the operation symbols.

### (Appendix 5)

The program generation device according to Appendix 4, wherein the processor, in response to selection of the reproduction symbol, displays the operation symbol group constituting the reproduction symbol on the display.

### (Appendix 6)

The program generation device according to Appendix 4 or 5, wherein the processor allows selection of the reproduction symbol displayed in the first region when creating different operation programs.

### (Appendix 7)

The program generation device according to any one of Appendices 4 to 6, wherein the processor: accepts input, via the input device, as to whether or not to maintain the parameter set to each of the operation symbols constituting the reproduction symbol when registering the reproduction symbol in the storage device; and in a case where the parameter is not to be maintained, registers the reproduction symbol in the storage device while resetting the parameter.

### (Appendix 8)

A program generation method comprising: reading at least one operation symbol, which includes information that relates to an operation command for a robot and is registered in advance within a storage device, from the storage device and displaying the at least one operation symbol in a first region of a display; reproducing one or more operation symbols, which are selected from the at least one operation symbol displayed in the first region, and arranging the one or more operation symbols in a second region of the display, thereby generating an operation program; accepting input of a parameter for a function represented by an operation symbol selected from the operation symbols displayed in the first region or the second region, thereby generating a parameter-including operation symbol; and registering the generated parameter-including operation symbol in the storage device as one of the operation symbols.

### (Appendix 9)

A program generation program for causing a computer to execute: reading at least one operation symbol, which includes information that relates to an operation command for a robot and is registered in advance within a storage device, from the storage device and displaying the at least one operation symbol in a first region of the display; reproducing one or more operation symbols, which are selected from the at least one operation symbol displayed in the first region, and arranging the one or more operation symbols in a second region of the display, thereby generating an operation program; accepting input of a parameter for a function represented by an operation symbol selected from the operation symbols displayed in the first region or the second region, thereby generating a parameter-including operation symbol; and registering the generated parameter-including operation symbol in the storage device as one of the operation symbols.

### (Appendix 10)

A program generation device comprising at least one processor, at least one storage device, a display, and an input device, wherein the processor: reads at least one operation symbol, which includes information that relates to an operation command for a robot and is registered in advance within the storage device, from the storage device and displays the at least one operation symbol in a first region of the display; reproduces one or more operation symbols, which are selected from the at least one operation symbol displayed in the first region, and arranges the resultant symbol in time series in a second region of the display, thereby generating an operation program; in response to selection of an operation symbol group including the plurality of operation symbols arrayed in the second region and execution of a reproduction operation, generates a single reproduction symbol representing the operation symbol group; and registers the generated reproduction symbol in the storage device as one of the operation symbols.

### REFERENCE SIGNS LIST

1 Program generation device
2 Processor
3 Storage device
4 Display
5 Input interface (input device)
10 Robot
A Selection region (first region)
B Creation region (second region)
I Icon (operation symbol)
I2 Reproduction icon (reproduction symbol)

1. A program generation device comprising at least one processor, at least one storage device, a display, and an input device, wherein the processor:
reads at least one operation symbol, which includes information that relates to an operation command for a robot and is registered in advance within the storage device, from the storage device and displays the at least one operation symbol in a first region of the display;
reproduces one or more operation symbols, which are selected from the at least one operation symbol displayed in the first region, and arranges the one or more operation symbols in a second region of the display, thereby generating an operation program;
accepts input, via the input device, of a parameter for a function represented by an operation symbol selected from the operation symbols displayed in the first region or the second region, thereby generating a parameter-including operation symbol; and
registers the generated parameter-including operation symbol in the storage device as one of the operation symbols.

2. The program generation device according to claim 1, wherein the processor:
accepts input, via the input device, of a name to be associated with the parameter-including operation symbol in response to registration of the parameter-including operation symbol in the storage device.

3. The program generation device according to claim 1, wherein the processor:
accepts, via the input device, editing of a parameter input to the parameter-including operation symbol in response to selection of the parameter-including operation symbol.

4. The program generation device according to claim 1, wherein the processor:
in response to selection of an operation symbol group including a plurality of the operation symbols arranged in the second region, generates a single reproduction symbol representing the operation symbol group; and
registers the generated reproduction symbol in the storage device as one of the operation symbols.

5. The program generation device according to claim 4, wherein the processor:
in response to selection of the reproduction symbol, displays the operation symbol group constituting the reproduction symbol on the display.

6. The program generation device according to claim 4, wherein
the processor:
allows selection of the reproduction symbol displayed in the first region when creating a different operation program.

7. The program generation device according to claim 4, wherein
the processor:
accepts input, via the input device, as to whether or not to maintain the parameter set to each of the operation symbols constituting the reproduction symbol when registering the reproduction symbol in the storage device; and
in a case where the parameter is not to be maintained, registers the reproduction symbol in the storage device while resetting the parameter.

8. A program generation method comprising:
reading at least one operation symbol, which includes information that relates to an operation command for a robot and is registered in advance within a storage device, from the storage device and displaying the at least one operation symbol in a first region of a display;
reproducing one or more operation symbols, which are selected from the at least one operation symbol displayed in the first region, and arranging the one or more operation symbols in a second region of the display, thereby generating an operation program;
accepting input of a parameter for a function represented by an operation symbol selected from the operation symbols displayed in the first region or the second region, thereby generating a parameter-including operation symbol; and
registering the generated parameter-including operation symbol in the storage device as one of the operation symbols.

9. A non-transitory computer readable storage medium storing a program generation program for causing a computer to execute:
reading at least one operation symbol, which includes information that relates to an operation command for a robot and is registered in advance within a storage device, from the storage device and displaying the at least one operation symbol in a first region of the display;
reproducing one or more operation symbols, which are selected from the at least one operation symbol displayed in the first region, and arranging the one or more operation symbols in a second region of the display, thereby generating an operation program;
accepting input of a parameter for a function represented by an operation symbol selected from the operation symbols displayed in the first region or the second region, thereby generating a parameter-including operation symbol; and
registering the generated parameter-including operation symbol in the storage device as one of the operation symbols.
